(19) United States
(12) Patent Application Publication
(10) Pub. No.: US 2024/0381220 A1
(43) Pub. Date: Nov. 14, 2024

(54) POLICY PROCESSING METHOD AND APPARATUS, AND NETWORK FUNCTION

(71) Applicant: VIVO MOBILE COMMUNICATION CO., LTD., Dongguan (CN)

(72) Inventor: Wen WANG, Dongguan (CN)

(73) Assignee: VIVO MOBILE COMMUNICATION CO., LTD., Dongguan (CN)

(21) Appl. No.: 18/784,890

(22) Filed: Jul. 25, 2024

Related U.S. Application Data
(63) Continuation of application No. PCT/CN2023/073278, filed on Jan. 20, 2023.

(30) Foreign Application Priority Data
Jan. 27, 2022 (CN) 202210102980.0

(51) Int. Cl. H04W 40/24; H04W 24/02

(52) U.S. Cl. CPC H04W 40/24; H04W 24/02

(57) ABSTRACT

A policy processing method and apparatus and a network function are provided. The policy processing method includes: sending, by a first network function, UE policy assistance information to a second network function, where the UE policy assistance information is used by the second network function to generate, configure, or update a policy of a target UE.

### CROSS-REFERENCE TO RELATED APPLICATIONS

This application is a continuation of International Application No. PCT/CN2023/073278, filed on Jan. 20, 2023, which claims priority to Chinese Patent Application No. 202210102980.0, filed Jan. 27, 2022. The entire contents of each of the above-identified applications are expressly incorporated herein by reference.

### TECHNICAL FIELD

This application belongs to the field of communication technologies, and in particular, to a policy processing method and apparatus and a network function.

### BACKGROUND

In a roaming scenario or a scenario of a Standalone Non-Public Network (SNPN) that is also referred to as a private network, configuration and update of a UE policy are generally provided by a Home Policy Control Function (H-PCF). Currently, the H-PCF is generally based on a predefined rule, for example, the UE policy is formulated and generated based on a protocol. In this way, a manner in which the H-PCF generates or configures the UE policy is relatively fixed, and a current actual situation of a roaming network, a visit network, or a current service network is not considered, and consequently, flexibility of the generated UE policy is poor.

### SUMMARY

Embodiments of this application provide a policy processing method and apparatus and a network function.

According to a first aspect, a policy processing method is provided, including:
sending, by a first network function, UE policy assistance information to a second network function, where the UE policy assistance information is used by the second network function to generate, configure, or update a policy of a target UE.

According to a second aspect, a policy processing method is provided, including:
receiving, by a second network function, UE policy assistance information sent by a first network function; and
generating, configuring, or updating, by the second network function, a policy of a target UE based on the UE policy assistance information.

According to a third aspect, a policy processing apparatus is provided, including:
a sending module, configured to send UE policy assistance information to a second network function, where the UE policy assistance information is used by the second network function to generate, configure, or update a policy of a target UE.

According to a fourth aspect, a policy processing apparatus is provided, including:
a receiving module, configured to receive UE policy assistance information sent by a first network function; and
a processing module, configured to generate, configure, or update a policy of a target UE based on the UE policy assistance information.

According to a fifth aspect, a network function is provided, including a processor and a memory. The memory stores a program or an instruction that can run on the processor, and when the program or the instruction is performed by the processor, the steps of the policy processing method according to the first aspect are implemented, or the steps of the policy processing method according to the second aspect are implemented.

According to a sixth aspect, a readable storage medium is provided. The readable storage medium stores a program or an instruction, and when the program or the instruction is executed by a processor, the steps of the policy processing method according to the first aspect are implemented, or the steps of the policy processing method according to the second aspect are implemented.

According to a seventh aspect, a chip is provided. The chip includes a processor and a communication interface, the communication interface is coupled to the processor, and the processor is configured to run a program or an instruction to implement the policy processing method according to the first aspect or the policy processing method according to the second aspect.

According to an eighth aspect, a computer program/program product is provided. The computer program/program product is stored in a storage medium, and the computer program/program product is executed by at least one processor to implement the policy processing method according to the first aspect or the policy processing method according to the second aspect.

According to a ninth aspect, a network side device is provided. The network side device includes the first network function according to the first aspect and the second network function according to the second aspect, and the network side device can implement the policy processing method according to the first aspect or implement the policy processing method according to the second aspect.

In the embodiments of this application, the first network function sends the UE policy assistance information to the second network function, so that the second network function can generate, configure, or update the policy of the target UE based on the UE policy assistance information.

### BRIEF DESCRIPTION OF DRAWINGS

FIG. 1 is a block diagram of a wireless communication system to which the embodiments of this application are applicable;

FIG. 2 is a first flowchart of a policy processing method according to an embodiment of this application;

FIG. 3 is a second flowchart of a policy processing method according to an embodiment of this application;

FIG. 4 is a third flowchart of a policy processing method according to an embodiment of this application;

FIG. 5 is a fourth flowchart of a policy processing method according to an embodiment of this application;

FIG. 6 is a fifth flowchart of a policy processing method according to an

embodiment of this application;

FIG. 7 is a sixth flowchart of a policy processing method according to an embodiment of this application;

FIG. 8 is a seventh flowchart of a policy processing method according to an embodiment of this application;

FIG. 9 is an eighth flowchart of a policy processing method according to an embodiment of this application;

FIG. 10 is a block diagram of a policy processing apparatus according to an embodiment of this application;

FIG. 11 is a block diagram of another policy processing apparatus according to an embodiment of this application; and

FIG. 12 is a block diagram of a network function according to an embodiment of this application.

### DETAILED DESCRIPTION

The following describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first,” “second,” and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

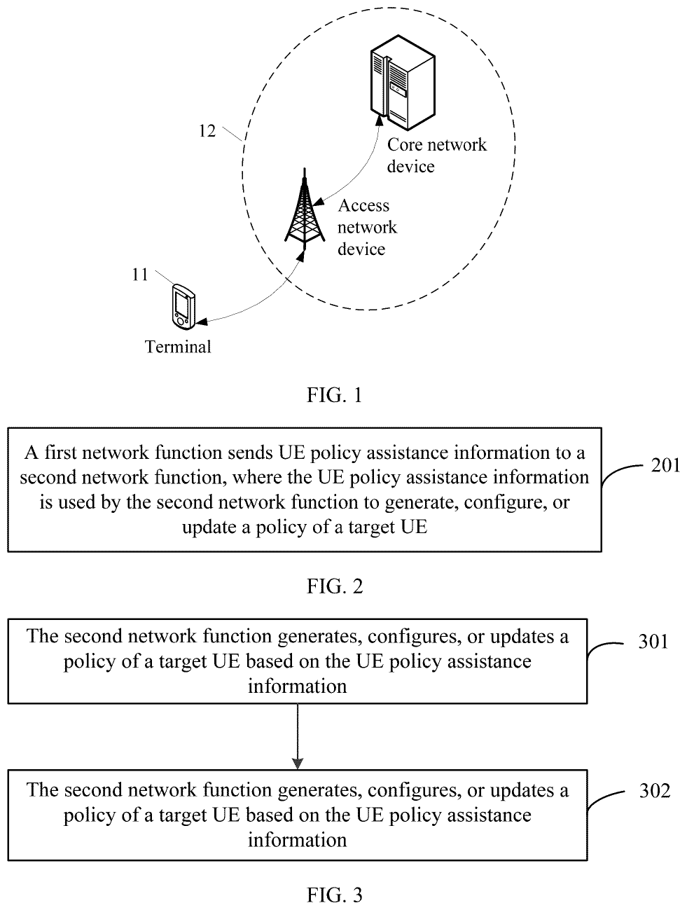

FIG. 1 is a block diagram of a wireless communication system to which the embodiments of this application may be applied. The wireless communication system includes a UE 11 and a network side device 12. The UE 11 may be a UE side device such as a mobile phone, a tablet personal computer, a laptop computer that is also referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home device (a home device with a wireless communication function, such as a refrigerator, a television, a washing machine, or furniture), a game console, a personal computer, a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. It should be noted that a specific type of the UE 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access point, a WiFi node, and the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another proper term in the art, provided that the same technical effects are achieved. The base station is not limited to a specific technical vocabulary. It should be noted that in the embodiments of this application, a base station in an NR system is merely used as an example for description, but does not limit a specific type of the base station. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), Unified Data Repository (UDR), a Home Subscriber Server (HSS), Centralized Network Configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

With reference to the accompanying drawings, a policy processing method in the embodiments of this application is described in detail below by using specific embodiments and application scenarios thereof.

FIG. 2 is a first flowchart of a policy processing method according to an embodiment of this application. As shown in FIG. 2, the policy processing method includes the following steps:

Step 201: A first network function sends UE policy assistance information to a second network function, where the UE policy assistance information is used by the second network function to generate, configure, or update a policy of a target UE.

The first network function may be a Visit Policy Control Function (V-PCF), and the second network function may be a Home Policy Control Function (H-PCF).

In this embodiment of this application, the first network function sends the UE policy assistance information to the second network function, that is, the V-PCF may send the UE policy assistance information to the H-PCF. The UE policy assistance information may be used to instruct the second network function to generate, configure, or update the policy of the target UE. Therefore, the H-PCF can generate, configure, or update the policy of the target UE based on the UE policy assistance information. In this way, the H-PCF can not only generate a UE policy based on a predetermined protocol, but can also dynamically configure and/or generate the UE policy based on the UE policy assistance information sent by the V-PCF, and can update the UE policy. In this way, flexibility of a manner in which the H-PCF generates the

UE policy can be effectively improved.

In some implementations, the policy includes a URSP of the UE, and certainly may further include another UE policy, such as a Vehicle-to-Everything policy (V2X policy), a Proximity Services policy (ProSe policy), or a direct communication interface PC5 ranging and positioning policy. This is not specifically limited in this embodiment of this application.

It should be noted that, the method provided in this embodiment of this application may be applied to a roaming scenario or a private network scenario. The second network function can generate a roaming policy of the UE based on the UE policy assistance information sent by the first network function. In this way, a current actual situation of a visit network or a private network and a specific requirement of a specific application in the visit network or the private network are considered in the UE policy generated by the second network function, thereby improving accuracy and flexibility of generating the UE policy by the second network function.

In some implementations, the UE policy assistance information includes at least one of the following:
a UE Route Selection Policy (URSP) of a visit network;
a service descriptor of the URSP of the visit network;
a route descriptor of the URSP of the visit network;
application information;
a Data Network Access Identifier (DNAI);
a Data Network Name (DNN);
slice information; and
location information of the target UE.

For example, the UE policy assistance information sent by the first network function to the second network function includes the URSP of the visit network, so that the second network function can determine, based on the URSP of the visit network, an association rule used by the target UE for a Protocol Data Unit (PDU) session, to generate a policy applicable to the target UE, for example, the policy includes a URSP of the UE.

For another example, the UE policy assistance information sent by the first network function to the second network function includes the application information, so that the second network function can determine, based on the application information, an application associated with the target UE, and can generate, based on the application information, a policy applicable to the target UE. In some implementations, the application information includes at least one of an application identity (identity, ID), an Internet Protocol (IP), an application requirement, and a Quality of Service (QOS) requirement.

For another example, the UE policy assistance information sent by the first network function to the second network function includes the DNAI, so that the second network function can determine, based on the DNAI, a DNAI that matches the target UE, to generate a UE policy that matches the DNAI.

It should be noted that there may be a plurality of other possible cases for specific content included in the UE policy assistance information, and the plurality of other cases are not listed one by one in this embodiment of this application.

In this embodiment of this application, before the first network function sends the UE policy assistance information to the second network function, the method may further include:
receiving, by the first network function, a first request or a subscription sent by the second network function, where the first request or the subscription is used to request to obtain the UE policy assistance information, or the first request or the subscription is used to obtain a subscription to the UE policy assistance information.

For example, the first network function receives a first request sent by the second network function, so that the first network function can send the UE policy assistance information to the second network function in a UE policy association creation process and/or a UE policy updating process based on the first request, or send a subscription to the UE policy assistance information to the second network function.

In some implementations, the first network function receives a subscription sent by the second network function, and the first network function sends the UE policy assistance information to the second network function based on the subscription in a UE policy association creation process and/or a UE policy updating process, or sends a subscription to the UE policy assistance information to the second network function.

It should be noted that, in a case that the second network function sends the first request, the first network function may respond to the first request only once, that is, send the UE policy assistance information or the subscription to the UE policy assistance information to the second network function based on the first request; and in a case that the second network function sends the subscription, the first network function can send the UE policy assistance information to the second network function in real time based on the subscription, for example, every time the UE policy assistance information is updated once, the first network function can send the updated UE policy assistance information to the second network function in real time.

In some implementations, the first request or the subscription includes at least one of the following:
a Visit Public Land Mobile Network (VPLMN) URSP obtaining indication;
a target UE identifier;
a target group identifier;
target application information;
target DNN information;
target slice information;
target DNAI information;
target service descriptor information; and
target route descriptor information.

The VPLMN URSP obtaining indication is used to instruct the first network function to provide a URSP of a VPLMN or a URSP list of the VPLMN.

The target UE identifier is used to indicate that the first network function provides the UE policy assistance information for the second network function only in a UE policy association creation process and/or a UE policy updating process indicated by the target UE identifier.

The target group identifier is used to indicate that the first network function provides the UE policy assistance information for the second network function only in a UE policy association creation process and/or a UE policy updating process of a UE in a group indicated by the target group identifier. The group indicated by the target group identifier may include one or more UEs.

The target application information is used to indicate that the first network function provides the UE policy assistance information for the second network function and/or provides UE policy assistance information associated with the target application information in a UE policy association creation process and/or a UE policy updating process of a UE associated with the target application information.

The target DNN information is used to indicate that the first network function provides the UE policy assistance information for the second network function and/or provides UE policy assistance information associated with the target DNN information in a UE policy association creation process and/or a UE policy updating process of a UE associated with the target DNN information.

The target slice information is used to indicate that the first network function provides the UE policy assistance information for the second network function and/or provides UE policy assistance information associated with the target slice information in a UE policy association creation process and/or a UE policy updating process of a UE associated with the target slice information. The slice information may be Single Network Slice Selection Assistance Information (S-NSSAI).

The target DNAI information is used to indicate that the first network function provides the UE policy assistance information for the second network function and/or provides UE policy assistance information associated with the target DNAI information in a UE policy association creation process and/or a UE policy updating process of a UE associated with the target DNAI information.

The target service descriptor information is used to indicate that the first network function provides the UE policy assistance information for the second network function and/or provides UE policy assistance information associated with the target service descriptor information in a UE policy association creation process and/or a UE policy updating process of a UE associated with the target service descriptor information.

The target route descriptor information is used to indicate that the first network function provides the UE policy assistance information for the second network function and/or provides UE policy assistance information associated with the target route descriptor information in a UE policy association creation process and/or a UE policy updating process of a UE associated with the target route descriptor information.

In some implementations, the sending, by the first network function, the UE policy assistance information to the second network function based on the first request or the subscription includes at least one of the following:
in a case that the first request includes the VPLMN URSP obtaining indication, sending, by the first network function, a VPLMN URSP to the second network function;
in a case that the first request includes the target UE identifier, sending, by the first network function, the UE policy assistance information to the second network function and/or sending UE policy assistance information associated with the target UE identifier to the second network function in a first target process, where the first target process is a UE policy association creation process and/or a UE policy updating process indicated by the target UE identifier;
in a case that the first request includes the target group identifier, sending, by the first network function, the UE policy assistance information to the second network function and/or sending UE policy assistance information associated with the group identifier to the second network function in a second target process, where the second target process is a UE policy association creation process and/or a UE policy updating process of a UE in a group indicated by the target group identifier;
in a case that the first request includes the target application information, sending, by the first network function, the UE policy assistance information to the second network function and/or sending UE policy assistance information associated with the target application information to the second network function in a third target process, where the third target process is a UE policy association creation process and/or a UE policy updating process of a UE associated with the target application information;
in a case that the first request includes the target DNN information, sending, by the first network function, the UE policy assistance information to the second network function and/or sending UE policy assistance information associated with the target DNN information to the second network function in a fourth target process, where the fourth target process is a UE policy association creation process and/or a UE policy updating process of a UE associated with the target DNN information;
in a case that the first request includes the target slice information, sending, by the first network function, the UE policy assistance information to the second network function and/or sending UE policy assistance information associated with the target slice information to the second network function in a fifth target process, where the fifth target process is a UE policy association creation process and/or a UE policy updating process of a UE associated with the target slice information;
in a case that the first request includes the target DNAI information, sending, by the first network function, the UE policy assistance information to the second network function and/or sending UE policy assistance information associated with the target DNAI information to the second network function in a sixth target process, where the sixth target process is a UE policy association creation process and/or a UE policy updating process of a UE associated with the target DNAI information;
in a case that the first request includes the target service descriptor information, sending, by the first network function, the UE policy assistance information to the second network function and/or sending UE policy assistance information associated with the target service descriptor information to the second network function in a seventh target process, where the seventh target process is a UE policy association creation process and/or a UE policy updating process of a UE that matches the target service descriptor information; and
in a case that the first request includes the target route descriptor information, sending, by the first network function, the UE policy assistance information to the second network function and/or sending UE policy assistance information associated with the target route descriptor information to the second network function in an eighth target process, where the eighth target process is a UE policy association creation process and/or a UE policy updating process of a UE that matches the target route descriptor information.

It should be noted that all the foregoing target processes include the UE policy association creation process and/or the UE policy updating process, where specific definitions of the first target process, the second target process, . . . , and the eighth target process are described above, and details are not described herein again. It may be understood that, based on different content included in the first request, the first network function can send the UE policy assistance information and/or send UE policy assistance information associated with the content included in the first request (for example, associated with the target UE identifier) to the second network function in a target process corresponding to the content included in the first request (for example, in the corresponding first target process if the first request includes the target UE identifier). In this way, the first network function can send the UE policy assistance information purposefully, thereby improving flexibility of configuring, generating, and updating the UE policy between the first network function and the second network function.

In some implementations, the target application information includes at least one of the following: an identifier of a target application and a service descriptor.

In some implementations, the target service descriptor information includes at least one of the following: an application descriptor, an IP descriptor, a non-IP descriptor, a domain descriptor, a DNN, and connection capability information.

In some implementations, the target route descriptor information includes at least one of the following: a session and service continuity mode, a network slice selection, a DNN, a non-seamless indication, and an access type preference.

In this embodiment of this application, in a case that the first request includes the target application information, the UE policy assistance information sent by the first network function includes at least one of the following: a QoS requirement, a DNN, slice information, a service descriptor, a URSP, a route descriptor, and a DNAI.

In some implementations, in a case that the first request includes the DNN information, the UE policy assistance information sent by the first network function is associated with a DNN corresponding to the DNN information, and the UE policy assistance information includes at least one of the following: a URSP, a DNAI, slice information, a service descriptor, and a route descriptor.

In some implementations, in a case that the first request includes the target slice information, the UE policy assistance information sent by the first network function is associated with a slice corresponding to the target slice information, and the UE policy assistance information includes at least one of the following: a URSP, a DNAI, a DNN, a service descriptor, and a route descriptor.

In some implementations, in a case that the first request includes the target DNAI information, the UE policy assistance information sent by the first network function is associated with a DNAI corresponding to the target DNAI information, and the UE policy assistance information includes at least one of the following: a URSP, slice information, a DNN, a service descriptor, and a route descriptor.

In some implementations, in a case that the first request includes the target service descriptor information, the UE policy assistance information sent by the first network function is associated with a service descriptor corresponding to the target service descriptor information, and the UE policy assistance information includes at least one of the following: a URSP, slice information, a DNN, and a route descriptor.

In some implementations, in a case that the first request includes the target route descriptor information, the UE policy assistance information sent by the first network function is associated with a route descriptor corresponding to the target route descriptor information, and the UE policy assistance information includes at least one of the following: a URSP, slice information, a DNN, and a service descriptor.

In this embodiment of this application, after the first network function sends the UE policy assistance information to the second network function, the method may further include:

receiving, by the first network function, a second request sent by the second network function, where the second request is used to instruct the first network function not to send the UE policy assistance information to the second network function in the UE policy association creation process or the UE policy updating process.

In some implementations, the second request may also be referred to as a de-subscription request. In a case that the first network function receives the second request, the first network function does not send the UE policy assistance information to the second network function again in the UE policy association creation process or the UE policy updating process. Therefore, the UE policy can be generated and updated based on dynamic interaction between the first network function and the second network function, so that the UE policy is generated and updated more dynamically and flexibly.

In some implementations, the method may further include:
receiving, by the first network function, an update request sent by the second network function; and
sending, by the first network function, updated UE policy assistance information to the second network function based on the update request.

In this embodiment of this application, the second network function can send an update request for the UE policy assistance information to the first network function, so that the first network function updates the UE policy assistance information based on the update request, and sends the updated UE policy assistance information to the second network function. Therefore, the second network function can generate or update the UE policy based on the updated UE policy assistance information, to ensure that the generated or updated UE policy can adapt to a current network situation and a current application requirement, thereby better ensuring a communication requirement of the UE.

FIG. 3 is a second flowchart of another policy processing method according to an embodiment of this application. As shown in FIG. 3, the policy processing method includes the following steps:

Step 301: A second network function receives UE policy assistance information sent by a first network function.

Step 302: The second network function generates, configures, or updates a policy of a target UE based on the UE policy assistance information.

In this embodiment of this application, the second network function receives the UE policy assistance information sent by the first network function, and the second network function can generate, configure, or update the policy of the target UE based on the UE policy assistance information. In this way, the second network function can not only generate the UE policy based on a predetermined protocol, but can also dynamically configure and/or generate the UE policy based on the UE policy assistance information sent by the first network function, and can update the UE policy. In this way, accuracy and flexibility of generating the UE policy by the second network function can be effectively improved.

In some implementations, the policy includes a URSP of the UE, and certainly may further include another UE policy. This is not specifically limited in this embodiment of this application. The first network function may be a V-PCF, and the second network function may be an H-PCF.

It should be noted that, the method provided in this embodiment of this application may be applied to a roaming scenario or a private network scenario. The second network function can generate a roaming policy of the UE based on the UE policy assistance information sent by the first network function. In this way, a current actual situation of a visit network or a private network and a specific requirement of a specific application in the visit network or the private network are considered in the UE policy generated by the second network function, thereby improving accuracy and flexibility of generating the UE policy by the second network function.

In some implementations, the UE policy assistance information includes at least one of the following:
a URSP of a visit network;
a service descriptor of the URSP of the visit network;
a route descriptor of the URSP of the visit network;
application information;
a DNAI;
a DNN;
slice information; and
location information of the target UE.

In some implementations, before the second network function receives the UE policy assistance information sent by the first network function, the method further includes:
sending, by the second network function, a first request or a subscription to the first network function, where the first request or the subscription is used to request to obtain the UE policy assistance information, or the first request or the subscription is used to obtain a subscription to the UE policy assistance information.

In some implementations, the first request or the subscription includes at least one of the following:
a VPLMN URSP obtaining indication;
a target UE identifier;
a target group identifier;
target application information;
target DNN information;
target slice information;
target DNAI information;
target service descriptor information; and
target route descriptor information.

In some implementations, that the second network function receives the UE policy assistance information sent by the first network function includes at least one of the following:
in a case that the first request includes the VPLMN URSP obtaining indication, receiving, by the second network function, a VPLMN URSP sent by the first network function;
in a case that the first request includes the target UE identifier, receiving, by the second network function, UE policy assistance information sent by the first network function in a first target process and/or UE policy assistance information associated with the target UE identifier, where the first target process is a UE policy association creation process and/or a UE policy updating process indicated by the target UE identifier;
in a case that the first request includes the target group identifier, receiving, by the second network function, UE policy assistance information sent by the first network function in a second target process and/or UE policy assistance information associated with the group identifier, where the second target process is a UE policy association creation process and/or a UE policy updating process of a UE in a group indicated by the target group identifier;
in a case that the first request includes the target application information, receiving, by the second network function, UE policy assistance information sent by the first network function in a third target process and/or UE policy assistance information associated with the target application information, where the third target process is a UE policy association creation process and/or a UE policy updating process of a UE associated with the target application information;
in a case that the first request includes the target DNN information, receiving, by the second network function, UE policy assistance information sent by the first network function in a fourth target process and/or UE policy assistance information associated with the target DNN information, where the fourth target process is a UE policy association creation process and/or a UE policy updating process of a UE associated with the target DNN information;
in a case that the first request includes the target slice information, receiving, by the second network function, UE policy assistance information sent by the first network function in a fifth target process and/or UE policy assistance information associated with the target slice information, where the fifth target process is a UE policy association creation process and/or a UE policy updating process of a UE associated with the target slice information;
in a case that the first request includes the target DNAI information, receiving, by the second network function, UE policy assistance information sent by the first network function in a sixth target process and/or UE policy assistance information associated with the target DNAI information, where the sixth target process is a UE policy association creation process and/or a UE policy updating process of a UE associated with the target DNAI information;
in a case that the first request includes the target service descriptor information, receiving, by the second network function, UE policy assistance information sent by the first network function in a seventh target process and/or UE policy assistance information associated with the target service descriptor information, where the seventh target process is a UE policy association creation process and/or a UE policy updating process of a UE that matches the target service descriptor information; and
in a case that the first request includes the target route descriptor information, receiving, by the second network function, UE policy assistance information sent by the first network function in an eighth target process and/or UE policy assistance information associated with the target route descriptor information, where the eighth target process is a UE policy association creation process and/or a UE policy updating process of a UE that matches the target route descriptor information.

In some implementations, the target application information includes at least one of the following: an identifier of a target application and a service descriptor.

In some implementations, the target service descriptor information includes at least one of the following: an application descriptor, an Internet Protocol IP descriptor, a non-IP descriptor, a domain descriptor, a DNN, and connection capability information.

In some implementations, the target route descriptor information includes at least one of the following: a session and service continuity mode, a network slice selection, a DNN, a non-seamless indication, and an access type preference.

In some implementations, in a case that the first request includes the target application information, the UE policy assistance information sent by the first network function includes at least one of the following: a quality of service QOS requirement, a DNN, slice information, a service descriptor, a URSP, a route descriptor, and a DNAI.

In some implementations, in a case that the first request includes the target DNN information, the UE policy assistance information sent by the first network function is associated with a DNN corresponding to the target DNN information, and the UE policy assistance information includes at least one of the following: a URSP, a DNAI, slice information, a service descriptor, and a route descriptor.

In some implementations, in a case that the first request includes the target slice information, the UE policy assistance information sent by the first network function is associated with a slice corresponding to the target slice information, and the UE policy assistance information includes at least one of the following: a URSP, a DNAI, a DNN, a service descriptor, and a route descriptor.

In some implementations, in a case that the first request includes the target DNAI information, the UE policy assistance information sent by the first network function is associated with a DNAI corresponding to the target DNAI information, and the UE policy assistance information includes at least one of the following: a URSP, slice information, a DNN, a service descriptor, and a route descriptor.

In some implementations, in a case that the first request includes the target service descriptor information, the UE policy assistance information sent by the first network function is associated with a service descriptor corresponding to the target service descriptor information, and the UE policy assistance information includes at least one of the following: a URSP, slice information, a DNN, and a route descriptor.

In some implementations, in a case that the first request includes the target route descriptor information, the UE policy assistance information sent by the first network function is associated with a route descriptor corresponding to the target route descriptor information, and the UE policy assistance information includes at least one of the following: a URSP, slice information, a DNN, and a service descriptor.

In some implementations, after the second network function receives the UE policy assistance information sent by the first network function, the method further includes:
sending, by the second network function, a second request to the first network function, where the second request is used to instruct the first network function not to send the UE policy assistance information to the second network function in the UE policy association creation process or the UE policy updating process.

In some implementations, after the second network function receives the UE policy assistance information sent by the first network function, the method further includes:
sending, by the second network function, an update request to the first network function, where the update request is used by the first network function to update the UE policy assistance information; and
receiving, by the second network function, updated UE policy assistance information sent by the first network function.

In this embodiment of this application, the second network function can generate, configure, or update the policy of the target UE based on the UE policy assistance information sent by the first network function. In this way, the second network function can not only generate the UE policy based on a predetermined protocol, but can also dynamically configure and/or generate the UE policy, and can update the UE policy. In this way, flexibility of a manner in which a network function generates or configures the UE policy can be effectively improved.

It should be noted that the policy processing method provided in this embodiment of this application is applied to the second network function, and is corresponding to the policy processing method applied to the first network function in the foregoing embodiment shown in FIG. 2. A related concept and a specific procedure in this embodiment of this application may be described with reference to the foregoing embodiment shown in FIG. 2. Details are not described again in this embodiment.

For better understanding, the technical solutions of this application are described below by using several embodiments with reference to specific scenarios.

### Embodiment 1

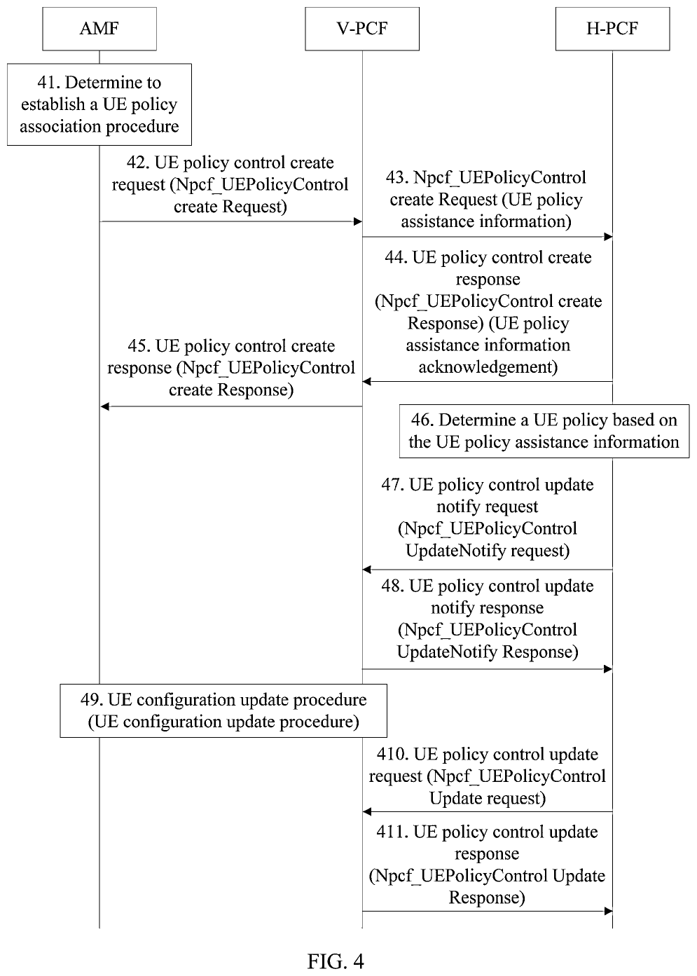

As shown in FIG. 4, FIG. 4 is a third flowchart of a policy processing method according to an embodiment of this application. As shown in FIG. 4, the policy processing method includes the following procedure:
Step 41: An AMF determines to establish a UE Policy Association procedure with a V-PCF.
Step 42: The AMF sends a UE policy control create request (Npcf_UEPolicyControl Create Request) to the V-PCF, where the request includes the following information: a Subscription Permanent Identifier (SUPI), a Permanent Equipment Identifier (PEI), User Location Information (ULI), a serving network, an H-PCF ID, and a UE policy container.
Step 43: After receiving the foregoing request, the V-PCF sends information included in the foregoing request to the H-PCF. The information is included in the UE policy control creation request (Npcf_UEPolicyControl Create Request). In addition, the request further includes UE policy assistance information. The UE policy assistance information is used by the H-PCF to generate, configure, or update a UE policy (including a URSP of a UE). The UE policy assistance information includes at least one of the following:
a) a recommended URSP or URSP rule;
b) a service descriptor;
c) a route descriptor;
d) application information;
e) an application ID and IP;
f) an application requirement and a QoS requirement;
g) a DNAI;
h) a DNN;
i) a slice; and
j) location information of the UE.
Step 44: The H-PCF sends a UE policy control create response (Npcf_UEPolicyControl Create Response) to the V-PCF, where the response includes a Policy Control Request Trigger parameters, and may further include UE policy assistance information acknowledgement information, indicating that the H-PCF determines that the UE policy assistance information is received, or determines to generate a UE policy by using the UE policy assistance information or a part of the UE policy assistance information.
Step 45: The V-PCF sends control create response (Npcf_UEPolicyControl Create Response) to the AMF.
Step 46: The H-PCF obtains subscription information related to the UE policy, a latest UE policy, and a UE policy that is generated based on the received UE policy assistance information and in which policy information of the V-PLMN is considered.
Step 47: The H-PCF sends the UE policy to the V-PCF by using a UE policy control update notify request (Npcf_UEPolicyControl UpdateNotify Request).
Step 48: The V-PCF sends a UE policy control update notify response (Npcf_UEPolicyControl UpdateNotify Response) to the H-PCF.
Step 49: The V-PCF triggers a UE Configuration Update Procedure, and in this procedure, adds the UE policy to a UE policy container and sends the UE policy container to the UE.
Step 410: If the V-PCF receives a notification, sent by the UE, that the UE policy is received, the V-PCF sends a UE policy control update request (Npcf_UEPolicyControl_Update Request) to the H-PCF.
Step 411: The H-PCF sends a UE policy control update response (Npcf_UEPolicyControl_Update Response) to the V-PCF.

In this embodiment, after receiving the UE policy control create request sent by the AMF, the V-PCF can send the UE policy assistance information to the H-PCF, so that the H-PCF can dynamically configure and/or generate the UE policy based on the UE policy assistance information sent by the V-PCF. In this way, flexibility of configuring the UE policy can be effectively improved.

### Embodiment 2

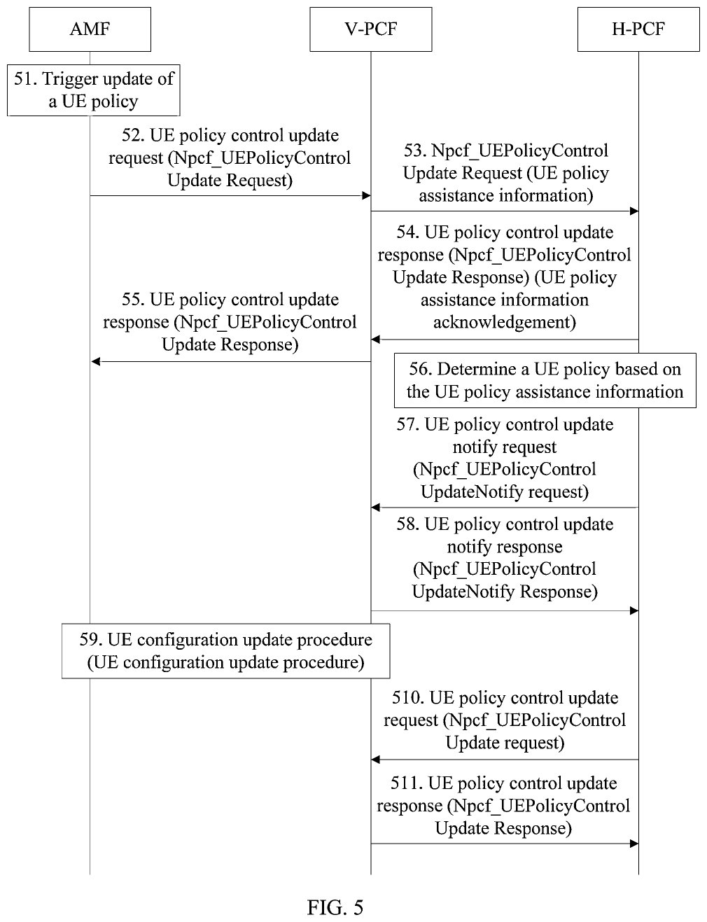

As shown in FIG. 5, FIG. 5 is a fourth flowchart of a policy processing method according to an embodiment of this application. As shown in FIG. 5, the policy processing method includes the following procedure:
Step 51: An AMF triggers update of a UE policy (update UE Policy Association).
Step 52: The AMF sends a UE policy control update request (Npcf_UEPolicyControl Update Request) to a V-PCF, where the request includes the following information: an SUPI, a PEI, a ULI, a serving network, an H-PCF ID, and a UE policy container.
Step 53: After receiving the foregoing request, the V-PCF sends information included in the foregoing request to an H-PCF, where the information is included in the UE policy control update request (Npcf_UEPolicyControl Update Request), and in addition, the request further includes UE policy assistance information. The UE policy assistance information is used by the H-PCF to determine or generate the UE policy (including a URSP of a UE), and the UE policy assistance information includes at least one of the following:
a) a recommended URSP or URSP rule;
b) a service descriptor;
c) a route descriptor;
d) application information;
e) an application ID and IP;
f) an application requirement and a QoS requirement;
g) a DNAI;
h) a DNN;
i) a slice; and
j) location information of the UE.
Step 54: The H-PCF sends a UE policy control update response (Npcf_UEPolicyControl Update Response) to the V-PCF, where the response may include a policy control request trigger parameter (Policy Control Request Trigger parameters), and may further include UE policy assistance information acknowledgment information, indicating that the H-PCF determines that the UE policy assistance information is received, or determines to generate the UE policy by using the UE policy assistance information or a part of the UE policy assistance information.
Step 55: The V-PCF sends the UE policy control update response (Npcf_UEPolicyControl Update Response) to the AMF.
Step 56: The H-PCF obtains subscription information related to the UE policy, a latest UE policy, and a UE policy that is generated based on the received UE policy assistance information and in which policy information of the V-PLMN is considered.
Step 57: The H-PCF sends the UE policy to the V-PCF by using a UE policy control update notify request (Npcf_UEPolicyControl UpdateNotify Request).
Step 58: The V-PCF sends a UE policy control update notify response (Npcf_UEPolicyControl UpdateNotify Response) to the H-PCF.
Step 59: The V-PCF triggers a UE configuration update procedure (UE Configuration Update Procedure), and in this procedure, adds the UE policy to a UE policy container (UE policy container) and sends the UE policy container to the UE.
Step 510: If the V-PCF receives a notification, sent by the UE, that the UE policy is received, the V-PCF sends a UE policy control update request (Npcf_UEPolicyControl_Update Request) to the H-PCF.
Step 511: The H-PCF sends a UE policy control update response (Npcf_UEPolicyControl_Update Response) to the V-PCF.

In this embodiment, in a UE policy updating process, the V-PCF can send the UE policy assistance information to the H-PCF based on the UE policy control update request sent by the AMF, and the H-PCF can dynamically configure and/or generate the UE policy based on the UE policy assistance information sent by the V-PCF, to update the UE policy.

### Embodiment 3

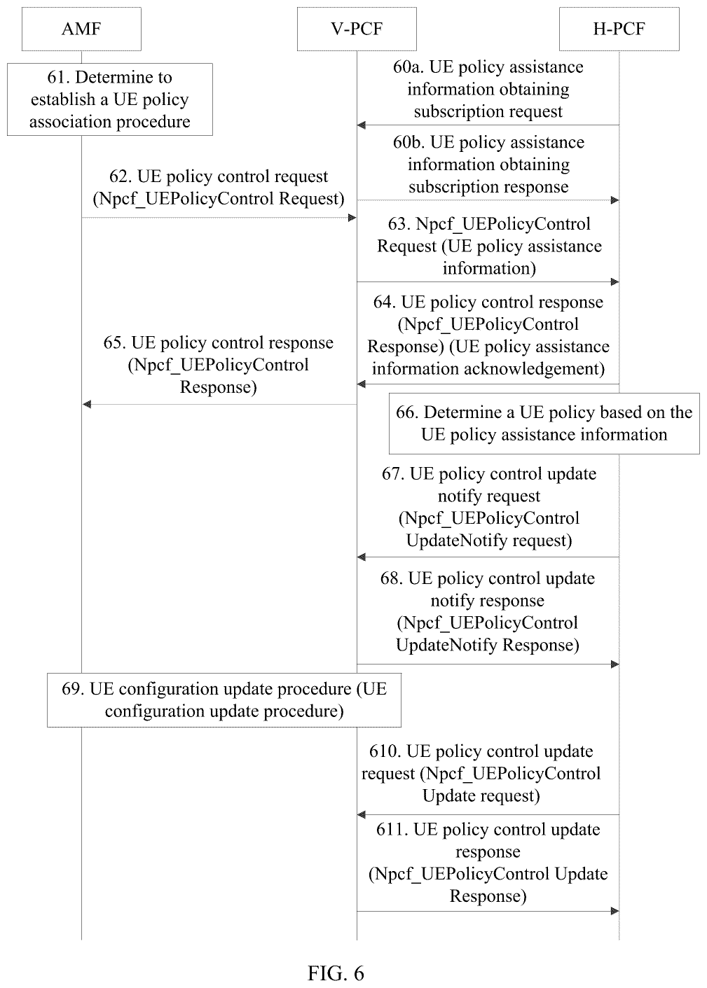

As shown in FIG. 6, FIG. 6 is a fifth flowchart of a policy processing method according to an embodiment of this application. As shown in FIG. 6, the policy processing method includes the following procedure:
Step 60a: An H-PCF sends a UE policy assistance information obtaining subscription request to a V-PCF, where the request carries at least one piece of the following information:
1. a VPLMN URSP obtaining indication or a VPLMN URSP list obtaining indication, used to instruct the V-PCF to provide a URSP or a URSP list of a VPLMN;
2. a UE identifier, used to indicate that the V-PCF provides the UE policy assistance information only on a specific UE;
3. a group identifier, used to indicate that the V-PCF provides the UE policy assistance information only in a specific group;
4. application information, used to indicate that only in a specific application, the V-PCF provides the UE policy assistance information and/or provides UE policy assistance information related to this application, where the application information includes at least one of the following: an application identifier and a service descriptor;
5. DNN information, used to indicate that only in a specific DNN, the V-PCF provides the UE policy assistance information and/or provides UE policy assistance information related to this DNN;
6. S-NSSAI information, used to indicate that only in a specific slice, the V-PCF provides the UE policy assistance information and/or provides UE policy assistance information related to this slice;
7. DNAI information, used to indicate that only in a specific DNAI, the V-PCF provides the UE policy assistance information and/or provides UE policy assistance information related to this DNAI;
8. service descriptor information, used to indicate that only in a specific service descriptor, the V-PCF provides the UE policy assistance information and/or provides UE policy assistance information related to this service descriptor, where the service descriptor information includes at least one of the following: an application descriptor, an IP descriptor, a non-IP descriptor, a domain descriptor, a DNN, and connection capability information; and
9. route descriptor information, used to indicate that only in a specific route descriptor, the V-PCF provides the UE policy assistance information and/or provides UE policy assistance information related to this route descriptor, where the route descriptor information includes at least one of the following: a session and service continuity mode, a network slice selection, a DNN, a non-seamless indication, and an access type preference.
Step 60b: The V-PCF sends a UE policy assistance information obtaining subscription response message to the H-PCF, where the response message carries acknowledgment information, and/or corresponding UE policy assistance information is generated based on information carried in the UE policy assistance information obtaining subscription request. This includes at least one of the following:
1. providing a URSP of a VPLMN for the H-PCF based on a VPLMN URSP or URSP list obtaining indication;
2. providing the UE policy assistance information for the H-PCF based on the UE identifier only in a UE policy association creation process or a UE policy updating process of a UE associated with the UE identifier;
3. providing the UE policy assistance information for the H-PCF based on the group identifier only in a UE policy association creation process or a UE policy updating process of a UE in a group associated with the group identifier;
4. proving the UE policy assistance information for the H-PCF based on the application information only in a UE policy association creation process or a UE policy updating process of a UE associated with the application information, and/or providing UE policy assistance information related to the application information, where the UE policy assistance information includes at least one of the following:
a QoS requirement;
a DNN;
a slice;
a service descriptor;
a URSP;
a route descriptor;
a DNAI;
5. providing the UE policy assistance information for the H-PCF based on the DNN information only in a UE policy association creation process or a UE policy updating process of a UE associated with the DNN information, and/or providing UE policy assistance information related to the DNN information, where the UE policy assistance information includes at least one of the following associated with the DNN:
a URSP;
a DNAI;
a slice;
a service descriptor; and
a route descriptor;
6. providing the UE policy assistance information for the H-PCF based on the slice information only in a UE policy association creation process or a UE policy updating process of a UE associated with the slice information, and/or providing UE policy assistance information related to the slice information, where the UE policy assistance information includes at least one of the following associated with the slice:
a URSP;
a DNAI;
a DNN;
a service descriptor; and
a route descriptor;
7. providing the UE policy assistance information for the H-PCF based on the DNAI information only in a UE policy association creation process or a UE policy updating process of a UE that matches the DNAI information, and/or providing UE policy assistance information related to the DNAI, where the UE policy assistance information includes at least one of the following associated with the DNAI:
a URSP;
a slice;
a DNN;
a service descriptor; and
a route descriptor;
8. providing the UE policy assistance information for the H-PCF based on the service descriptor information only in a UE policy association creation process or a UE policy updating process of a UE that matches the service descriptor information, and/or providing UE policy assistance information related to the service descriptor information, where the UE policy assistance information includes at least one of the following associated with the service descriptor:
a URSP;
a slice;
a DNN; and
a route descriptor;
9. providing the UE policy assistance information for the H-PCF based on the route descriptor information only in a UE policy association creation process or a UE policy updating process of a UE that matches the route descriptor information, and/or providing UE policy assistance information related to the route descriptor information, where the UE policy assistance information includes at least one of the following associated with the route descriptor:
a URSP;
a slice;
a DNN; and
a service descriptor.
Step 61: An AMF determines to establish a UE policy association (UE Policy Association) procedure with the V-PCF.
Step 62: The AMF sends a UE policy control request (Npcf_UEPolicyControl Request) to the V-PCF, where the request includes the following information: an SUPI, a PEI, a ULI, a serving network, an H-PCF ID, and a UE policy container.

Step 63: After receiving the foregoing request, the V-PCF sends information included in the foregoing request to the H-PCF, where the information is included in a UE policy control request (Npcf_UEPolicyControl Request), and further includes the corresponding UE policy assistance information generated based on the information carried in the UE policy assistance information obtaining subscription request. This includes at least one of the following:
a. providing a URSP of a VPLMN for the H-PCF based on a VPLMN URSP/URSP list obtaining indication;
b. providing the UE policy assistance information for the H-PCF based on the UE identifier only in a UE policy association creation process or a UE policy updating process of a UE associated with the UE identifier;
c. providing the UE policy assistance information for the H-PCF based on the group identifier only in a UE policy association creation process or a UE policy updating process of a UE in a group associated with the group identifier;
d. providing the UE policy assistance information for the H-PCF based on the application information only in a UE policy association creation process or a UE policy updating process of a UE associated with the application information, and/or providing UE policy assistance information related to the application information, where the UE policy assistance information includes at least one of the following:
a QoS requirement;
a DNN;
a slice;
a service descriptor;
a URSP;
a route descriptor; and
a DNAI;
e. providing the UE policy assistance information for the H-PCF based on the DNN information only in a UE policy association creation process or a UE policy updating process of a UE associated with the DNN information, and/or providing UE policy assistance information related to the DNN information, where the UE policy assistance information includes at least one of the following associated with the DNN:
a URSP;
a DNAI;
a slice;
a service descriptor; and
a route descriptor;
f. providing the UE policy assistance information for the H-PCF based on the slice information only in a UE policy association creation process or a UE policy updating process of a UE associated with the slice information, and/or providing UE policy assistance information related to the slice information, where the UE policy assistance information includes at least one of the following associated with the slice:
a URSP;
a DNAI;
a DNN;
a service descriptor; and
a route descriptor;
g. providing the UE policy assistance information for the H-PCF based on the DNAI information only in a UE policy association creation process or a UE policy updating process of a UE that matches the DNAI information, and/or providing UE policy assistance information related to the DNAI, where the UE policy assistance information includes at least one of the following associated with the DNAI:
a URSP;
a slice;
a DNN;
a service descriptor; and
a route descriptor;
h. providing the UE policy assistance information for the H-PCF based on the service descriptor information only in a UE policy association creation process or a UE policy updating process of a UE that matches the service descriptor information, and/or providing UE policy assistance information related to the service descriptor information, where the UE policy assistance information includes at least one of the following associated with the service descriptor:
a URSP;
a slice;
a DNN; and
a route descriptor;
i. providing the UE policy assistance information for the H-PCF based on the route descriptor information only in a UE policy association creation process or a UE policy updating process of a UE that matches the route descriptor information, and/or providing UE policy assistance information related to the route descriptor information, where the UE policy assistance information includes at least one of the following associated with the route descriptor:
a URSP;
a slice;
a DNN; and
a service descriptor.
Step 64: The H-PCF sends a UE policy control response (Npcf_UEPolicyControl Response) to the V-PCF, where the response may include a policy control request trigger parameter (Policy Control Request Trigger parameters), and may further include UE policy assistance information acknowledgement information, indicating that the H-PCF determines that the UE policy assistance information is received, or determines to generate a UE policy by using the UE policy assistance information or a part of the UE policy assistance information.
Step 65: The V-PCF sends the UE policy control response (Npcf_UEPolicyControl Response) to the AMF.
Step 66: The H-PCF obtains subscription information related to the UE policy, a latest UE policy, and a UE policy that is generated based on the received UE policy assistance information and in which policy information of the V-PLMN is considered.
Step 67: The H-PCF sends the UE policy to the V-PCF by using a UE policy control update notify request (Npcf_UEPolicyControl UpdateNotify Request).
Step 68: The V-PCF sends a UE policy control update notify response (Npcf_UEPolicyControl UpdateNotify Response) to the H-PCF.
Step 69: The V-PCF triggers a UE configuration update procedure (UE Configuration Update Procedure), and in this procedure, adds the UE policy to a UE policy container (UE policy container) and sends the UE policy container to the UE.
Step 610: If the V-PCF receives a notification, sent by the UE, that the UE policy is received, the V-PCF sends a UE policy control update request (Npcf_UEPolicyControl_Update Request) to the H-PCF.
Step 611: The H-PCF sends a UE policy control update response (Npcf_UEPolicyControl_Update Response) to the V-PCF.

In this embodiment, the H-PCF can actively send the UE policy assistance information obtaining subscription request to the V-PCF, and further, the V-PCF can generate corresponding UE policy assistance information based on information carried in the request, and send the corresponding UE policy assistance information to the H-PCF, so that the H-PCF configures and generates the UE policy purposefully, thereby effectively improving flexibility of generating and configuring the UE policy, and being better applicable to a current network.

### Embodiment 4

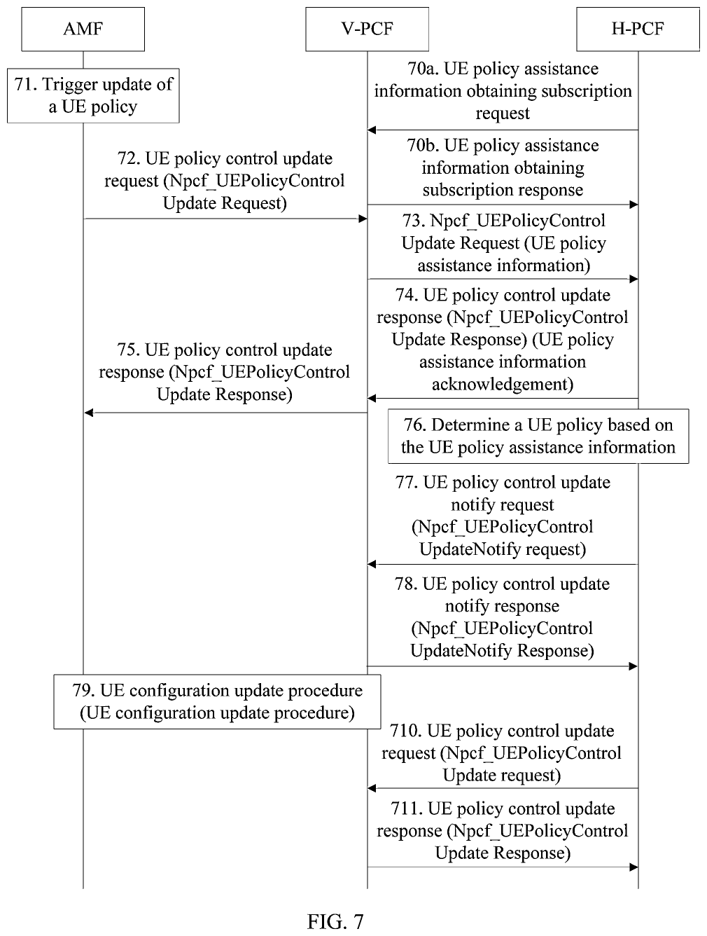

As shown in FIG. 7, FIG. 7 is a sixth flowchart of a policy processing method according to an embodiment of this application. As shown in FIG. 7, the policy processing method includes the following procedure:
Step 70a: An H-PCF sends a UE policy assistance information obtaining subscription request to a V-PCF, where the request carries at least one piece of the following information: a VPLMN URSP obtaining indication or a VPLMN URSP list obtaining indication, a UE identifier, a group identifier, application information, DNN information, S-NSSAI information, DNAI information, service descriptor information, and route descriptor information.
Step 70b: The V-PCF sends UE policy assistance information obtaining subscription response message to the H-PCF, where the response message carries acknowledgement information; and/or generates corresponding UE policy assistance information based on information carried in the UE policy assistance information obtaining subscription request (for details of this step, reference may be made to step 60b in Embodiment 3, and the details are not described herein again).
Step 71: An AMF triggers update of a UE policy (update UE Policy Association).
Step 72: The AMF sends a UE policy control update request (Npcf_UEPolicyControl Update Request) to the V-PCF, where the request includes the following information: an SUPI, a PEI, a ULI, a serving network, an H-PCF ID, and a UE policy container.
Step 73: After receiving the foregoing request, the V-PCF sends the information included in the foregoing request to the H-PCF, where the information is included in the UE policy control update request (Npcf_UEPolicyControl Update Request), and the request further includes the UE policy assistance information and further includes the corresponding UE policy assistance information generated based on the information carried in the UE policy assistance information obtaining subscription request (for details of this step, reference may be made to step 63 in Embodiment 3, and the details are not described herein again.)
Step 74: The H-PCF sends a UE policy control update response (Npcf_UEPolicyControl Update Response) to the V-PCF, where the response may include a policy control request trigger parameter (Policy Control Request Trigger parameters), and may further include UE policy assistance information acknowledgment information, indicating that the H-PCF determines that the UE policy assistance information is received, or determines to generate the UE policy by using the UE policy assistance information or a part of the UE policy assistance information.
Step 75: The V-PCF sends the UE policy control update response (Npcf_UEPolicyControl Update Response) to the AMF.
Step 76: The H-PCF obtains subscription information related to the UE policy, a latest UE policy, and a UE policy that is generated based on the received UE policy assistance information and in which policy information of a V-PLMN is considered.
Step 77: The H-PCF sends the UE policy to the V-PCF by using a UE policy control update notify request (Npcf_UEPolicyControl UpdateNotify Request).
Step 78: The V-PCF sends a UE policy control update notify response (Npcf_UEPolicyControl UpdateNotify Response) to the H-PCF.
Step 79: The V-PCF triggers a UE configuration update procedure (UE Configuration Update Procedure), and in this procedure, adds the UE policy to a UE policy container (UE policy container) and sends the UE policy container to the UE.
Step 710: If the V-PCF receives a notification, sent by the UE, that the UE policy is received, the V-PCF sends a UE policy control update request (Npcf_UEPolicyControl_Update Request) to the H-PCF.
Step 711: The H-PCF sends a UE policy control update response (Npcf_UEPolicyControl_Update Response) to the V-PCF.

In this embodiment, in a UE policy updating process, the H-PCF can first send the UE policy assistance information obtaining subscription request to the V-PCF, so that the V-PCF can generate the corresponding UE policy assistance information based on the information carried in the request and send the corresponding UE policy assistance information to the H-PCF, and then the H-PCF updates the UE policy, thereby effectively improving flexibility of updating the UE policy, to better adapt to a current network.

### Embodiment 5

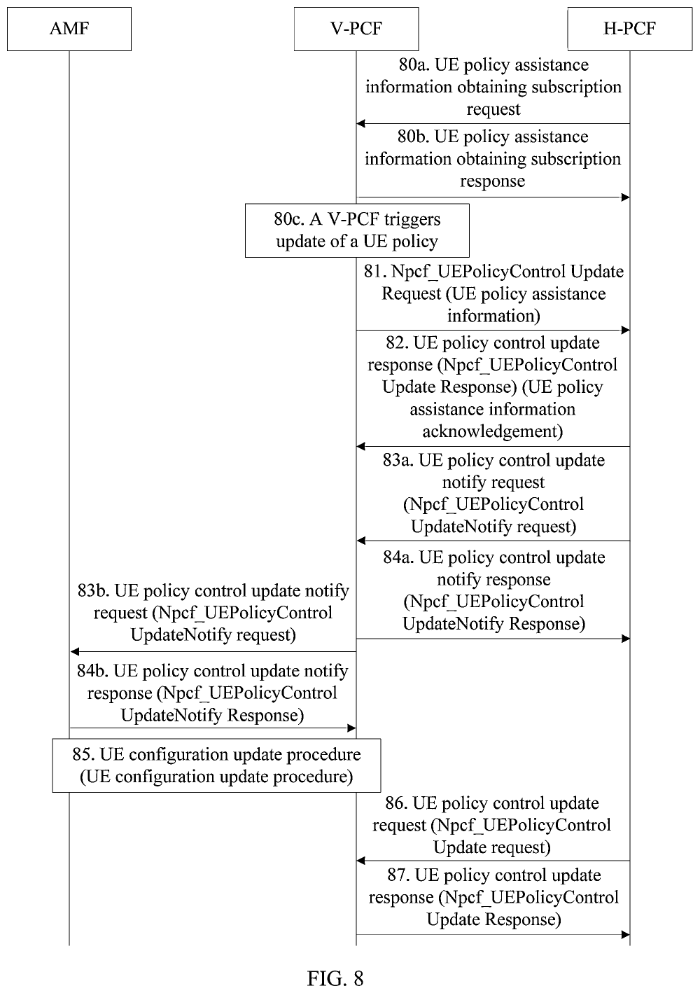

As shown in FIG. 8, FIG. 8 is a seventh flowchart of a policy processing method according to an embodiment of this application. As shown in FIG. 8, the policy processing method includes the following procedure:
Step 80a: An H-PCF sends a UE policy assistance information obtaining subscription request to a V-PCF, where the request carries at least one piece of the following information: a VPLMN URSP obtaining indication or a VPLMN URSP list obtaining indication, a UE identifier, a group identifier, application information, DNN information, S-NSSAI information, DNAI information, service descriptor information, and route descriptor information.
Step 80b: The V-PCF sends a UE policy assistance information obtaining subscription response message to the H-PCF, where the response message carries acknowledgment information and/or corresponding UE policy assistance information generated based on information carried in the UE policy assistance information obtaining subscription request (for details of this step, refer to step 60b in Embodiment 3, and the details are not described herein again).
Step 80c: The V-PCF triggers update of a UE policy.
Step 81: The V-PCF sends a UE policy control update request (Npcf_UEPolicyControl Update Request) to the H-PCF, where the request includes the corresponding UE policy assistance information generated based on the information carried in the UE policy assistance information obtaining subscription request (for details of this step, reference may be made to step 63 in Embodiment 3, and the details are not described herein again).
Step 82: The H-PCF sends a UE policy control update response (Npcf_UEPolicyControl Update Response) to the V-PCF, where the response may include a policy control request trigger parameter (Policy Control Request Trigger parameters), and may further include UE policy assistance information acknowledgment information, indicating that the H-PCF determines that the UE policy assistance information is received, or determines to generate the UE policy by using the UE policy assistance information or a part of the UE policy assistance information.
Step 83a: The H-PCF generates the UE policy and sends a UE policy control update notify request (Npcf_UEPolicyControl UpdateNotify Request) to the V-PCF.
Step 83b: The V-PCF sends a UE policy control update notify request (Npcf_UEPolicyControl UpdateNotify Request) to an AMF.
Step 84a: The V-PCF sends a UE policy control update notify response (Npcf_UEPolicyControl UpdateNotify Response) to the H-PCF.
Step 84b: The AMF sends a UE policy control update notify response (Npcf_UEPolicyControl UpdateNotify Response) to the V-PCF.
Step 85: The V-PCF triggers a UE configuration update procedure (UE Configuration Update Procedure).
Step 86: If the V-PCF receives a notification, sent by the UE, that the UE policy is received, the V-PCF sends a UE policy control update request (Npcf_UEPolicyControl_Update Request) to the H-PCF.
Step 87: The H-PCF sends a UE policy control update response (Npcf_UEPolicyControl_Update Response) to the V-PCF.

In this embodiment, the V-PCF can trigger a UE policy updating process, and the H-PCF can first actively send the UE policy assistance information obtaining subscription request to the V-PCF, so that the V-PCF can generate corresponding UE policy assistance information based on information carried in the request and send the corresponding UE policy assistance information to the H-PCF, and then the H-PCF updates the UE policy, thereby effectively improving flexibility of updating the UE policy, to better adapt to a current network.

### Embodiment 6

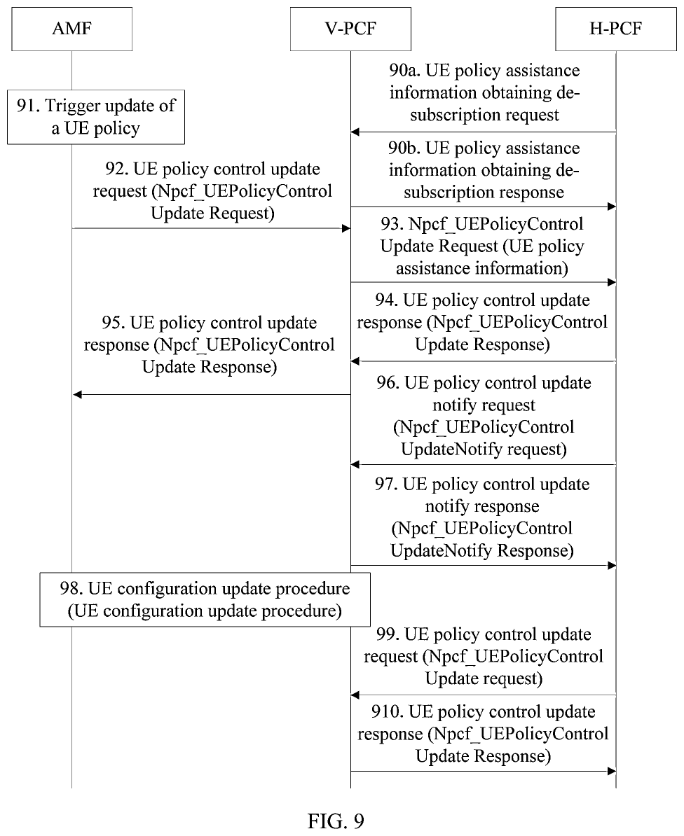

As shown in FIG. 9, FIG. 9 is an eighth flowchart of a policy processing method according to an embodiment of this application. As shown in FIG. 9, the policy processing method includes the following procedure:
Step 90a: An H-PCF sends a UE policy assistance information obtaining de-subscription request to a V-PCF, where the de-subscription request is used by the V-PCF not to send UE policy assistance information to the H-PCF in a subsequent process.
Step 90b: The V-PCF sends a UE policy assistance information obtaining de-subscription response to the H-PCF.
Step 91: An AMF triggers update of a UE policy (update UE Policy Association).
Step 92: The AMF sends a UE policy control update request (Npcf_UEPolicyControl Update Request) to the V-PCF.
Step 93: After receiving the foregoing request, the V-PCF sends a UE policy control update request (Npcf_UEPolicyControl Update Request) to the H-PCF.
Step 94: The H-PCF sends a UE policy control update response (Npcf_UEPolicyControl Update Response) to the V-PCF.
Step 95: The V-PCF sends the UE policy control update response (Npcf_UEPolicyControl Update Response) to the AMF.
Step 96: The H-PCF sends a UE policy control update notify request (Npcf_UEPolicyControl UpdateNotify Request) to the V-PCF.
Step 97: The V-PCF sends a UE policy control update notify response (Npcf_UEPolicyControl UpdateNotify Response) to the H-PCF.
Step 98: The V-PCF triggers a UE configuration update procedure (UE Configuration Update Procedure).
Step 99: The V-PCF sends a UE policy control update request (Npcf_UEPolicyControl_Update Request) to the H-PCF.
Step 910: The H-PCF sends a UE policy control update response (Npcf_UEPolicyControl_Update Response) to the V-PCF.

In this embodiment, the H-PCF can send the UE policy assistance information obtaining de-subscription request to the V-PCF, so that the V-PCF does not send the UE policy assistance information to the H-PCF in a subsequent process based on the de-subscription request.

The policy processing method provided in the embodiments of this application may be performed by a policy processing apparatus. In an embodiment of this application, that the policy processing apparatus performs the policy processing method is used as an example to describe the policy processing apparatus according to this embodiment of this application.

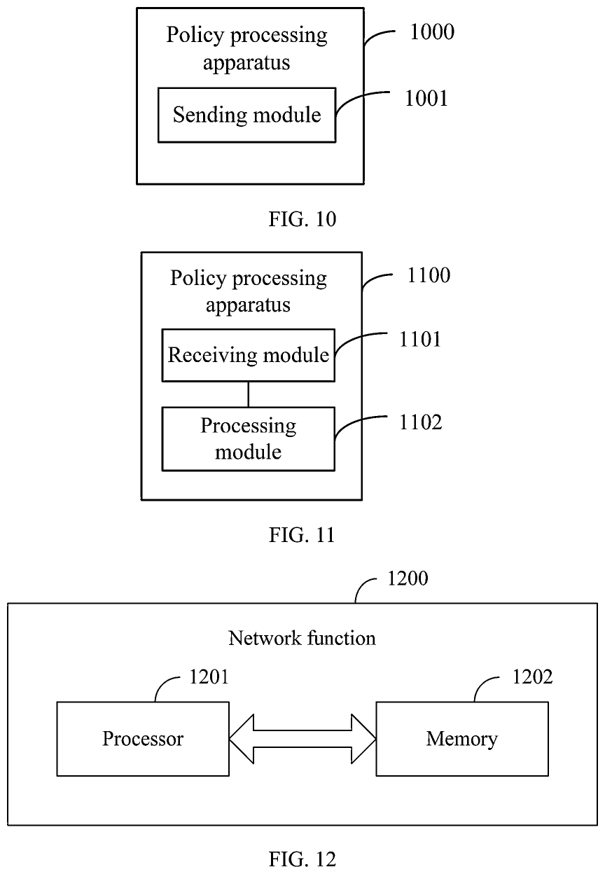

FIG. 10 is a diagram of a structure of a policy processing apparatus according to an embodiment of this application. As shown in FIG. 10, the policy processing apparatus 1000 includes:
a sending module 1001, configured to send UE policy assistance information to a second network function, where the UE policy assistance information is used by the second network function to generate, configure, or update a policy of a target UE.

In some implementations, the UE policy assistance information includes at least one of the following:
a UE route selection policy URSP of a visit network;
a service descriptor of the URSP of the visit network;
a route descriptor of the URSP of the visit network;
application information;
a data network access identifier DNAI;
a data network name DNN;
slice information; and
location information of the target UE.

In some implementations, the apparatus further includes:
a first receiving module, configured to receive a first request or a subscription sent by the second network function, where the first request or the subscription is used to request to obtain the UE policy assistance information, or the first request or the subscription is used to obtain a subscription to the UE policy assistance information.

In some implementations, the first request or the subscription includes at least one of the following:
a visit public land mobile network VPLMN URSP obtaining indication;
a target UE identifier;
a target group identifier;
target application information;
target DNN information;
target slice information;
target DNAI information;
target service descriptor information; and
target route descriptor information.

In some implementations, the sending module 1001 is specifically configured to perform at least one of the following:
in a case that the first request includes the VPLMN URSP obtaining indication, sending a VPLMN URSP to the second network function;
in a case that the first request includes the target UE identifier, sending the UE policy assistance information to the second network function and/or sending UE policy assistance information associated with the target UE identifier to the second network function in a first target process, where the first target process is a UE policy association creation process and/or a UE policy updating process indicated by the target UE identifier;
in a case that the first request includes the target group identifier, sending the UE policy assistance information to the second network function and/or sending UE policy assistance information associated with the group identifier to the second network function in a second target process, where the second target process is a UE policy association creation process and/or a UE policy updating process of a UE in a group indicated by the target group identifier;
in a case that second network function includes the target application information, sending the UE policy assistance information to the second network function and/or UE policy assistance information associated with the target application information to the second network function in a third target process, where the third target process is a UE policy association creation process and/or a UE policy updating process of a UE associated with the target application information;
in a case that the first request includes the target DNN information, sending the UE policy assistance information to the second network function and/or sending UE policy assistance information associated with the target DNN information to the second network function in a fourth target process, where the fourth target process is a UE policy association creation process and/or a UE policy updating process of a UE associated with the target DNN information;
in a case that the first request includes the target slice information, sending the UE policy assistance information to the second network function and/or sending UE policy assistance information associated with the target slice information to the second network function in a fifth target process, where the fifth target process is a UE policy association creation process and/or a UE policy updating process of a UE associated with the target slice information;
in a case that the first request includes the target DNAI information, sending the UE policy assistance information to the second network function and/or sending UE policy assistance information associated with the target DNAI information to the second network function in a sixth target process, where the sixth target process is a UE policy association creation process and/or a UE policy updating process of a UE associated with the target DNAI information;
in a case that the first request includes the target service descriptor information, sending the UE policy assistance information to the second network function and/or sending UE policy assistance information associated with the target service descriptor information to the second network function in a seventh target process, where the seventh target process is a UE policy association creation process and/or a UE policy updating process of a UE that matches the target service descriptor information; and
in a case that the first request includes the target route descriptor information, sending the UE policy assistance information to the second network function and/or sending

UE policy assistance information associated with the target route descriptor information to the second network function in an eighth target process, where the eighth target process is a UE policy association creation process and/or a UE policy updating process of a UE that matches the target route descriptor information.

In some implementations, the target application information includes at least one of the following: an identifier of a target application and a service descriptor.

In some implementations, the target service descriptor information includes at least one of the following: an application descriptor, an Internet Protocol IP descriptor, a non-IP descriptor, a domain descriptor, a DNN, and connection capability information.

In some implementations, the target route descriptor information includes at least one of the following: a session and service continuity mode, a network slice selection, a DNN, a non-seamless indication, and an access type preference.

In some implementations, in a case that the first request includes the target application information, the UE policy assistance information sent by the apparatus includes at least one of the following: a quality of service QoS requirement, a DNN, slice information, a service descriptor, a URSP, a route descriptor, and a DNAI.

In some implementations, in a case that the first request includes the target DNN information, the UE policy assistance information sent by the apparatus is associated with a DNN corresponding to the target DNN information, and the UE policy assistance information includes at least one of the following: a URSP, a DNAI, slice information, a service descriptor, and a route descriptor.

In some implementations, in a case that the first request includes the target slice information, the UE policy assistance information sent by the apparatus is associated with a slice corresponding to the target slice information, and the UE policy assistance information includes at least one of the following: a URSP, a DNAI, a DNN, a service descriptor, and a route descriptor.

In some implementations, in a case that the first request includes the target DNAI information, the UE policy assistance information sent by the apparatus is associated with a DNAI corresponding to the target DNAI information, and the UE policy assistance information includes at least one of the following: a URSP, slice information, a DNN, a service descriptor, and a route descriptor.

In some implementations, in a case that the first request includes the target service descriptor information, the UE policy assistance information sent by the apparatus is associated with a service descriptor corresponding to the target service descriptor information, and the UE policy assistance information includes at least one of the following: a URSP, slice information, a DNN, and a route descriptor.

In some implementations, in a case that the first request includes the target route descriptor information, the UE policy assistance information sent by the apparatus is associated with a route descriptor corresponding to the target route descriptor information, and the UE policy assistance information includes at least one of the following: a URSP, slice information, a DNN, and a service descriptor.

In some implementations, the apparatus further includes:
a second receiving module, configured to receive a second request sent by the second network function, where the second request is used to instruct the apparatus not to send the UE policy assistance information to the second network function in the UE policy association creation process or the UE policy updating process.

In some implementations, the apparatus further includes:
a third receiving module, configured to receive an update request sent by the second network function.

The sending module 1001 is further configured to send updated UE policy assistance information to the second network function based on the update request.

The apparatus provided in this embodiment of this application can send the UE policy assistance information to the second network function, so that the second network function can generate, configure, or update the policy of the target UE based on the UE policy assistance information. In this way, the second network function can not only dynamically configure and/or generate the UE policy based on a predetermined protocol, but can also update the UE policy. In this way, accuracy and flexibility of a manner in which a network function generates or configures the UE policy can be effectively improved.

The policy processing apparatus provided in this embodiment of this application can implement the processes implemented in the method embodiment shown in FIG. 2, and achieve a same technical effect. To avoid repetition, details are not provided herein again.

FIG. 11 is a diagram of a structure of another policy processing apparatus according

to an embodiment of this application. As shown in FIG. 11, the policy processing apparatus 1100 includes:
a receiving module 1101, configured to receive UE policy assistance information sent by a first network function; and
a processing module 1102, configured to generate, configure, or update a policy of a target UE based on the UE policy assistance information.

In some implementations, the UE policy assistance information includes at least one of the following:
a UE route selection policy URSP of a visit network;
a service descriptor of the URSP of the visit network;
a route descriptor of the URSP of the visit network;
application information;
a data network access identifier DNAI;
a data network name DNN;
slice information; and
location information of the target UE.

In some implementations, the apparatus further includes:
a first sending module, configured to send a first request or a subscription to the first network function, where the first request or the subscription is used to request to obtain the UE policy assistance information, or the first request or the subscription is used to obtain a subscription to the UE policy assistance information.

In some implementations, the first request or the subscription includes at least one of the following:
a visit public land mobile network VPLMN URSP obtaining indication;
a target UE identifier;
a target group identifier;
target application information;
target DNN information;
target slice information;
target DNAI information;
target service descriptor information; and
target route descriptor information.

In some implementations, the receiving module 1101 is further configured to perform at least one of the following:
in a case that the first request includes the VPLMN URSP obtaining indication, receiving a first VPLMN URSP sent by the first network function;
in a case that the first request includes the target UE identifier, receiving UE policy assistance information sent by the first network function in a first target process and/or UE policy assistance information associated with the target UE identifier, where the first target process is a UE policy association creation process and/or a UE policy updating process indicated by the target UE identifier;
in a case that the first request includes the target group identifier, receiving UE policy assistance information sent by the first network function in a second target process and/or UE policy assistance information associated with the group identifier, where the second target process is a UE policy association creation process and/or a UE policy updating process of a UE in a group indicated by the target group identifier;
in a case that the first request includes the target application information, receiving UE policy assistance information sent by the first network function in a third target process and/or UE policy assistance information associated with the target application information, where the third target process is a UE policy association creation process and/or a UE policy updating process of a UE associated with the target application information;
in a case that the first request includes the target DNN information, receiving UE policy assistance information sent by the first network function in a fourth target process and/or UE policy assistance information associated with the target DNN information, where the fourth target process is a UE policy association creation process and/or a UE policy updating process of a UE associated with the target DNN information;
in a case that the first request includes the target slice information, receiving UE policy assistance information sent by the first network function in a fifth target process and/or UE policy assistance information associated with the target slice information, where the fifth target process is a UE policy association creation process and/or a UE policy updating process of a UE associated with the target slice information;
in a case that the first request includes the target DNAI information, receiving UE policy assistance information sent by the first network function in a sixth target process and/or UE policy assistance information associated with the target DNAI information, where the sixth target process is a UE policy association creation process and/or a UE policy updating process of a UE associated with the target DNAI information;
in a case that the first request includes the target service descriptor information, receiving UE policy assistance information sent by the first network function in a seventh target process and/or UE policy assistance information associated with the target service descriptor information, where the seventh target process is a UE policy association creation process and/or a UE policy updating process of a UE that matches the target service descriptor information; and
in a case that the first request includes the target route descriptor information, receiving UE policy assistance information sent by the first network function in an eighth target process and/or UE policy assistance information associated with the target route descriptor information, where the eighth target process is a UE policy association creation process and/or a UE policy updating process of a UE that matches the target route descriptor information.

In some implementations, the target application information includes at least one of the following: an identifier of a target application and a service descriptor.

In some implementations, the target service descriptor information includes at least one of the following: an application descriptor, an Internet Protocol IP descriptor, a non-IP descriptor, a domain descriptor, a DNN, and connection capability information.

In some implementations, the target route descriptor information includes at least one of the following: a session and service continuity mode, a network slice selection, a DNN, a non-seamless indication, and an access type preference.

In some implementations, in a case that the first request includes the target application information, the UE policy assistance information sent by the first network function includes at least one of the following: a quality of service QoS requirement, a DNN, slice information, a service descriptor, a URSP, a route descriptor, and a DNAI.

In some implementations, in a case that the first request includes the target DNN information, the UE policy assistance information sent by the first network function is associated with a DNN corresponding to the target DNN information, and the UE policy assistance information includes at least one of the following: a URSP, a DNAI, slice information, a service descriptor, and a route descriptor.

In some implementations, in a case that the first request includes the target slice information, the UE policy assistance information sent by the first network function is associated with a slice corresponding to the target slice information, and the UE policy assistance information includes at least one of the following: a URSP, a DNAI, a DNN, a service descriptor, and a route descriptor.

In some implementations, in a case that the first request includes the target DNAI information, the UE policy assistance information sent by the first network function is associated with a DNAI corresponding to the target DNAI information, and the UE policy assistance information includes at least one of the following: a URSP, slice information, a DNN, a service descriptor, and a route descriptor.

In some implementations, in a case that the first request includes the target service descriptor information, the UE policy assistance information sent by the first network function is associated with a service descriptor corresponding to the target service descriptor information, and the UE policy assistance information includes at least one of the following: a URSP, slice information, a DNN, and a route descriptor.

In some implementations, in a case that the first request includes the target route descriptor information, the UE policy assistance information sent by the first network function is associated with a route descriptor corresponding to the target route descriptor information, and the UE policy assistance information includes at least one of the following: a URSP, slice information, a DNN, and a service descriptor.

In some implementations, the apparatus further includes:
a second sending module, configured to send a second request to the first network function, where the second request is used to instruct the first network function not to send the UE policy assistance information to the apparatus in the UE policy association creation process or the UE policy updating process.

In some implementations, the apparatus further includes:
a third sending module, configured to send an update request to the first network function, where the update request is used by the first network function to update the UE policy assistance information.

The receiving module 1101 is further configured to receive updated UE policy assistance information sent by the first network function.

The apparatus provided in this embodiment of this application can generate, configure, or update the policy of the target UE based on the UE policy assistance information sent by the first network function. In this way, the apparatus can not only generate the UE policy based on a predetermined protocol, but can also dynamically configure and/or generate the UE policy, and can update the UE policy. In this way, accuracy and flexibility of a manner in which a network function generates or configures the UE policy can be effectively improved.

The policy processing apparatus provided in this embodiment of this application can implement the processes implemented in the method embodiment shown in FIG. 3, and achieve a same technical effect. To avoid repetition, details are not provided herein again.

In some implementations, as shown in FIG. 12, an embodiment of this application further provides a network function 1200, including a processor 1201, a memory 1202. A program or an instruction that is capable of running on the processor 1201 is stored on the memory 1202. For example, in a case that the network function 1200 is a first network function, when the program or the instruction is executed by the processor 1201, the steps of the method embodiment in FIG. 2 are implemented, and a same technical effect can be achieved. In a case that the network function 1200 is a second network function, when the program or the instruction is executed by the processor 1201, the steps of the method embodiment in FIG. 3 are implemented, and a same technical effect can be achieved. To avoid repetition, details are not described herein again.

An embodiment of this application further provides a readable storage medium. The readable storage medium stores a program or an instruction, and when the program or the instruction is executed by a processor, the processes of the method embodiment in FIG. 2 are implemented, or the processes of the method embodiment in FIG. 3 are implemented, and a same technical effect can be achieved. To avoid repetition, details are not described herein again.

The processor is a processor in the UE in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the method embodiment in FIG. 2 or implement the processes of the method embodiment in FIG. 3, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a storage medium, and the computer program/program product is executed by at least one processor to implement the processes of the method embodiment in FIG. 2 or implement the processes of the method embodiment in FIG. 3, and a same technical effect can be achieved. To avoid repetition, details are not described herein again.

An embodiment of this application further provides a network side device, including a first network function and a second network function. The first network function may be configured to perform the steps of the policy processing method described in FIG. 2 and the embodiments of this application, and the second network function may be configured to perform the steps of the policy processing method described in FIG. 3 and the embodiments of this application.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a UE (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A policy processing method, perform by a first network function, comprising:
sending User Equipment (UE) policy assistance information to a second network function, wherein the UE policy assistance information is used to generate, configure, or update a policy of a target UE.

2. The policy processing method according to claim 1, wherein the UE policy assistance information comprises at least one of the following:
a UE Route Selection Policy (URSP) of a visit network;
a service descriptor of the URSP of the visit network;
a route descriptor of the URSP of the visit network;
application information;
a Data Network Access Identifier (DNAI);
a Data Network Name (DNN);
slice information; or
location information of the target UE.

3. The policy processing method according to claim 1, wherein before the sending UE policy assistance information to a second network function, the policy processing method further comprises:
receiving a first request or a subscription sent by the second network function, wherein the first request or the subscription is used to request to obtain the UE policy assistance information, or the first request or the subscription is used to obtain a subscription to the UE policy assistance information.

4. The policy processing method according to claim 3, wherein the first request or the subscription comprises at least one of the following:
a Visit Public Land Mobile Network (VPLMN) UE Route Selection Policy (URSP) obtaining indication;
a target UE identifier;
a target group identifier;
target application information;
target Data Network Name (DNN) information;
target slice information;
target Data Network Access Identifier (DNAI) information;
target service descriptor information; or
target route descriptor information.

5. The policy processing method according to claim 4, wherein the sending UE policy assistance information to a second network function comprises at least one of the following:
when the first request comprises the VPLMN URSP obtaining indication, sending a VPLMN URSP to the second network function;
when the first request comprises the target UE identifier, sending the UE policy assistance information to the second network function or sending UE policy assistance information associated with the target UE identifier to the second network function in a first target process, wherein the first target process is a UE policy association creation process or a UE policy updating process indicated by the target UE identifier;
when the first request comprises the target group identifier, sending the UE policy assistance information to the second network function or sending UE policy assistance information associated with the group identifier to the second network function in a second target process, wherein the second target process is a UE policy association creation process or a UE policy updating process of a UE in a group indicated by the target group identifier;
when the first request comprises the target application information, sending the UE policy assistance information to the second network function or sending UE policy assistance information associated with the target application information to the second network function in a third target process, wherein the third target process is a UE policy association creation process or a UE policy updating process of a UE associated with the target application information;
when the first request comprises the target DNN information, sending the UE policy assistance information to the second network function or sending UE policy assistance information associated with the target DNN information to the second network function in a fourth target process, wherein the fourth target process is a UE policy association creation process or a UE policy updating process of a UE associated with the target DNN information;
when the first request comprises the target slice information, sending the UE policy assistance information to the second network function or sending UE policy assistance information associated with the target slice information to the second network function in a fifth target process, wherein the fifth target process is a UE policy association creation process or a UE policy updating process of a UE associated with the target slice information;
when the first request comprises the target DNAI information, sending the UE policy assistance information to the second network function or sending UE policy assistance information associated with the target DNAI information to the second network function in a sixth target process, wherein the sixth target process is a UE policy association creation process or a UE policy updating process of a UE associated with the target DNAI information;
when the first request comprises the target service descriptor information, sending the UE policy assistance information to the second network function or sending UE policy assistance information associated with the target service descriptor information to the second network function in a seventh target process, wherein the seventh target process is a UE policy association creation process or a UE policy updating process of a UE that matches the target service descriptor information; or
when the first request comprises the target route descriptor information, sending the UE policy assistance information to the second network function or sending UE policy assistance information associated with the target route descriptor information to the second network function in an eighth target process, wherein the eighth target process is a UE policy association creation process or a UE policy updating process of a UE that matches the target route descriptor information.

6. The policy processing method according to claim 4, wherein the target application information comprises at least one of an identifier of a target application or a service descriptor.

7. The policy processing method according to claim 4, wherein the target service descriptor information comprises at least one of an application descriptor, an Internet Protocol (IP) descriptor, a non-IP descriptor, a domain descriptor, a DNN, or connection capability information.

8. The policy processing method according to claim 4, wherein the target route descriptor information comprises at least one of a session and service continuity mode, a network slice selection, a DNN, a non-seamless indication, or an access type preference.

9. The policy processing method according to claim 4, wherein when the first request comprises the target application information, the UE policy assistance information sent by the first network function comprises at least one of the following: a Quality of Service (QOS) requirement, a DNN, slice information, a service descriptor, a URSP, a route descriptor, or a DNAI.

10. The policy processing method according to claim 4, wherein when the first request comprises the target DNN information, the UE policy assistance information sent by the first network function is associated with a DNN corresponding to the target DNN information, and the UE policy assistance information comprises at least one of the following: a URSP, a DNAI, slice information, a service descriptor, or a route descriptor.

11. The policy processing method according to claim 4, wherein when the first request comprises the target slice information, the UE policy assistance information sent by the first network function is associated with a slice corresponding to the target slice information, and the UE policy assistance information comprises at least one of the following: a URSP, a DNAI, a DNN, a service descriptor, or a route descriptor.

12. The policy processing method according to claim 4, wherein when the first request comprises the target DNAI information, the UE policy assistance information sent by the first network function is associated with a DNAI corresponding to the target DNAI information, and the UE policy assistance information comprises at least one of the following: a URSP, slice information, a DNN, a service descriptor, or a route descriptor.

13. The policy processing method according to claim 4, wherein when the first request comprises the target service descriptor information, the UE policy assistance information sent by the first network function is associated with a service descriptor corresponding to the target service descriptor information, and the UE policy assistance information comprises at least one of the following: a URSP, slice information, a DNN, or a route descriptor.

14. The policy processing method according to claim 4, wherein when the first request comprises the target route descriptor information, the UE policy assistance information sent by the first network function is associated with a route descriptor corresponding to the target route descriptor information, and the UE policy assistance information comprises at least one of the following: a URSP, slice information, a DNN, or a service descriptor.

15. The policy processing method according to claim 1, wherein after the sending UE policy assistance information to a second network function, the policy processing method further comprises:
receiving a second request sent by the second network function, wherein the second request is used to instruct the first network function not to send the UE policy assistance information to the second network function in the UE policy association creation process or the UE policy updating process.

16. The policy processing method according to claim 1, further comprising:
receiving an update request sent by the second network function; and
sending updated UE policy assistance information to the second network function based on the update request.

17. A first network function, comprising:
a memory storing computer-readable instructions; and
a processor coupled to the memory and configured to execute the computer-readable instructions, wherein the computer-readable instructions, when executed by the processor, cause the processor to perform operations comprising:
sending User Equipment (UE) policy assistance information to a second network function, wherein the UE policy assistance information is used to generate, configure, or update a policy of a target UE.

18. The first network function according to claim 17, wherein the UE policy assistance information comprises at least one of the following:
a UE Route Selection Policy (URSP) of a visit network;
a service descriptor of the URSP of the visit network;
a route descriptor of the URSP of the visit network;
application information;
a Data Network Access Identifier (DNAI);
a Data Network Name (DNN);
slice information; or
location information of the target UE.

19. A non-transitory computer-readable medium storing instructions that, when executed by a processor of a first network function, cause the processor to perform operations comprising:
sending User Equipment (UE) policy assistance information to a second network function, wherein the UE policy assistance information is used to generate, configure, or update a policy of a target UE.

20. The non-transitory computer-readable medium according to claim 19, wherein the UE policy assistance information comprises at least one of the following:
a UE Route Selection Policy (URSP) of a visit network;
a service descriptor of the URSP of the visit network;
a route descriptor of the URSP of the visit network;
application information;
a Data Network Access Identifier (DNAI);
a Data Network Name (DNN);
slice information; or
location information of the target UE.
